(19) United States
(12) Patent Application Publication
(10) Pub. No.: US 2012/0311369 A1
(43) Pub. Date: Dec. 6, 2012

(54) IMAGE FORMING APPARATUS, POWER CONTROL METHOD THEREFOR, AND STORAGE MEDIUM STORING POWER CONTROL PROGRAM THEREFOR

(75) Inventor: Minoru Kambegawa, Yokohama-shi (JP)

(73) Assignee: CANON KABUSHIKI KAISHA, Tokyo (JP)

(21) Appl. No.: 13/486,041

(22) Filed: Jun. 1, 2012

(30) Foreign Application Priority Data
Jun. 1, 2011 (JP) 2011-123642

(51) Int. Cl. G06F 1/26

(52) U.S. Cl. 713/340

(57) ABSTRACT

An image forming apparatus that is capable of reducing power consumption by controlling electric power without employing a complex control in a unit of a small-scale module. The image forming apparatus executes processes concerning image formation in units of modules. A waiting unit makes a module wait an execution of a process until power supply stabilization time lapses after starting power supply to the module as a power control target. A measurement unit measures lapsed time until the power control target module has processed predetermined unit data after starting power supply. A determination unit determines whether the power supply to the power control target module is turned OFF based on the lapsed time acquired by the measurement unit.

### BACKGROUND OF THE INVENTION

1. Field of the Invention

The present invention relates to an image forming apparatus, a power control method therefor, and a storage medium storing a power control program. Particularly, the present invention relates to a power control technique for controlling power supplied to blocks of which power supplies are isolated under operations.

2. Description of the Related Art

There are a large number of proposals about power saving because power saving becomes big concern in view of the battle against global warming. For example, Japanese Laid-Open Patent Publication (Kokai) No. 2003-185716 (JP 2003-185716A) discloses a technique that controls power consumption of peripheral equipment connected to a CPU and a bus. The technique detects a start and an end of an access from the CPU, and controls a sleep mode of the peripheral equipment based on the detection result.

Although the technique of the above-mentioned publication aims to save power by controlling electric power of a products system, a power saving technology inside a LSI is progressing in recent years. For example, there is a technique that suspends clock of an unnecessary module for an operation by a clock gating technology, a technique that isolates power supplies inside an LSI and turns off a power supply of an unnecessary module for an operation, etc. In particular, a power supply isolation technology saves electric power by turning off power of a module that is unnecessary by means of a software-based control in a sleep mode.

However, the technique described in JP 2003-185716A and the power supply isolation technology reduce the power consumption by turning off a power supply of a large module, while the power to a controlling part, such as a CPU, is applied in a specified mode like the sleep mode. In order to reduce power consumption more, it is necessary to control a power supply in a unit of a smaller-scale module during operation.

Since the number of modules that are targets to be controlled increases when the power supply is controlled in a unit of a small-scale module, the software-based control complicates a process and increases processing time, which may adversely affect an operation performance.

Since a certain time is required until a power state is stabilized and becomes usable after turning on a power supply of a target module, a turning off of the power supply may adversely affect an operation performance when a quick response is required.

### SUMMARY OF THE INVENTION

The present invention provides a technique that is capable of reducing power consumption by controlling electric power without employing a complex control in a unit of a small-scale module.

Accordingly, a first aspect of the present invention provides an image forming apparatus that executes processes concerning image formation in units of modules, comprising a waiting unit configured to make a module wait an execution of a process until power supply stabilization time lapses after starting power supply to the module as a power control target, a measurement unit configured to measure lapsed time until the power control target module has processed predetermined unit data after starting power supply, and a determination unit configured to determine whether the power supply to the power control target module is turned OFF based on the lapsed time acquired by the measurement unit.

Accordingly, a second aspect of the present invention provides an image forming apparatus that executes processes concerning image formation in units of modules, comprising a waiting unit configured to make a module wait an execution of a process until power supply stabilization time lapses after starting power supply to the module as a power control target, a measurement unit configured to measure first lapsed time until the power control target module has processed predetermined unit data after starting power supply, a determination unit configured to determine whether the power supply to the power control target module is turned OFF based on the first lapsed time acquired by the measurement unit, a decision unit configured to decide second lapsed time until the power supply is turned ON next after turning OFF, and a power control unit configured to turn ON the power supply to the power control target module in response to a data effective signal inputted to the module concerned, to turn OFF the power supply to the power control target module when the determination unit determines to turn OFF, and to turn ON the power supply when the second lapsed time lapses after turning OFF the power supply concerned.

Accordingly, a third aspect of the present invention provides a power control method for an image forming apparatus that executes processes concerning image formation in units of modules, the power control method comprising a power-ON step of turning ON a power supply to a power control target module in response to a data effective signal inputted to the module concerned, a waiting step of making the power control target module wait an execution of a process until power supply stabilization time lapses after starting power supply to the module in the power-ON step, a measurement step of measuring lapsed time until the power control target module has processed predetermined unit data after starting power supply in the power-ON step, a determination step of determining whether the power supply to the power control target module is turned OFF based on the lapsed time acquired in the measurement step, and a power-OFF step of turning OFF the power supply to the power control target module when determining to be turned OFF in the determination step.

Accordingly, a fourth aspect of the present invention provides a power control method for an image forming apparatus that executes processes concerning image formation in units of modules, the power control method comprising a first power-ON step of turning ON a power supply to a power control target module in response to a data effective signal inputted to the module concerned, a waiting step of making the power control target module wait an execution of a process until power supply stabilization time lapses after starting power supply to the module in the first power-ON step, a measurement step of measuring first lapsed time until the power control target module has processed predetermined unit data after starting power supply in the power-ON step, a determination step of determining whether the power supply to the power control target module is turned OFF based on the first lapsed time acquired in the measurement step, a power-OFF step of turning OFF the power supply to the power control target module when determining to be turned OFF in the determination step, a decision step of deciding second lapsed time until the power supply is turned ON next after turning OFF in the power-OFF step, and a second power-ON step of turning ON the power supply when the second lapsed time lapses after turning OFF the power supply in the power-OFF step.

Accordingly, a fifth aspect of the present invention provides a non-transitory computer-readable storage medium storing a control program causing a computer to execute the control method of the third aspect.

Accordingly, a sixth aspect of the present invention provides a non-transitory computer-readable storage medium storing a control program causing a computer to execute the control method of the fourth aspect.

According to the present invention, the power consumption can be reduced by controlling electric power without employing a complex control in a unit of a small-scale module.

Further features of the present invention will become apparent from the following description of exemplary embodiments with reference to the attached drawings.

### BRIEF DESCRIPTION OF THE DRAWINGS

FIG. 1 is a block diagram schematically showing a hardware configuration of an image forming apparatus according to an embodiment of the present invention.

FIG. 2 is a block diagram schematically showing a functional configuration of a controller in FIG. 1.

FIG. 3 is a view showing an example of image data for 1 page that is divided into a plurality of bands as a processing unit of image data.

FIG. 4 is a block diagram schematically showing currents of signals between a printer-aimed image processing block in FIG. 2 and a power control circuit.

FIG. 5 is a flowchart showing a power control process by the power control circuit in a first embodiment.

FIG. 6 is a view showing waveform examples of various bus signals shown in FIG. 4 during the power control process.

FIG. 7A is a view showing a power control method for a power control target module under a condition where ON time is shorter than a specified value in the first embodiment.

FIG. 7B is a view showing the power control method for the power control target module under a condition where the ON time is longer than the specified value in the first embodiment.

FIG. 8 is a flowchart showing a power control process by the power control circuit in a second embodiment.

FIG. 9 is a view showing a power control method for a power control target module under a condition where the ON time is shorter than a specified value in the second embodiment.

FIG. 10A is a view showing the power control method for the power control target module in the first embodiment.

FIG. 10B is a view showing the power control method for the power control target module in a third embodiment.

### DESCRIPTION OF THE EMBODIMENTS

Hereafter, embodiments according to the present invention will be described in detail with reference to the drawings.

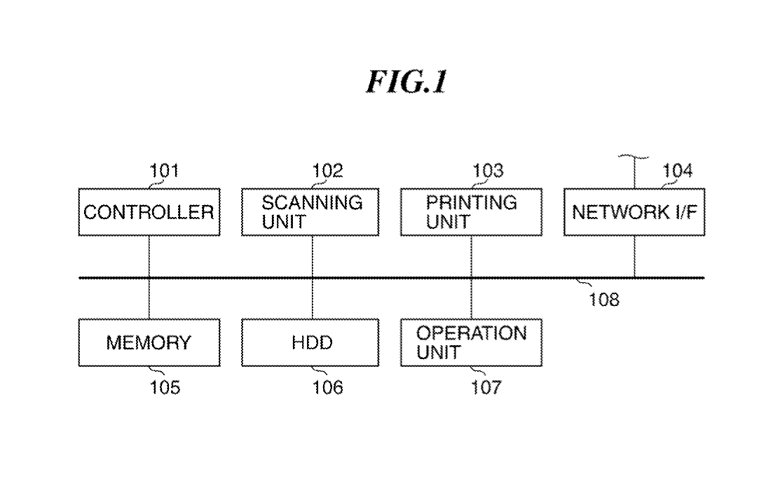

FIG. 1 is a block diagram schematically showing a hardware configuration of an image forming apparatus according to an embodiment of the present invention.

The image forming apparatus according to the embodiment of the present invention is a digital multifunctional peripheral device (referred to as an “MFP”, hereafter) that is provided with a scanner function, a printer function, a copy function, etc., for example. The MFP is provided with a controller 101, a scanner unit 102, a printer unit 103, a network I/F 104, a memory 105, an HDD 106, and an operation unit 107 as illustrated.

The controller 101 is connected to the scanner unit 102 that is an image input device and the printer unit 103 that is an image output device via a system bus 108, and controls them. The controller 101 is connected to a LAN, a public telephone line (WAN), etc. via the network I/F 104, and enables input/output of image information, and development of PDL (Page Description Language) data.

The memory 105 is a system work memory for an operation of the controller 101, and is also an image memory for storing image data temporarily. The HDD (hard disk drive) 106 stores system software and image data. The operation unit 107 is a user interface, which consists of a touch panel, a keyboard, etc., through which a user of the MFP performs various print settings etc.

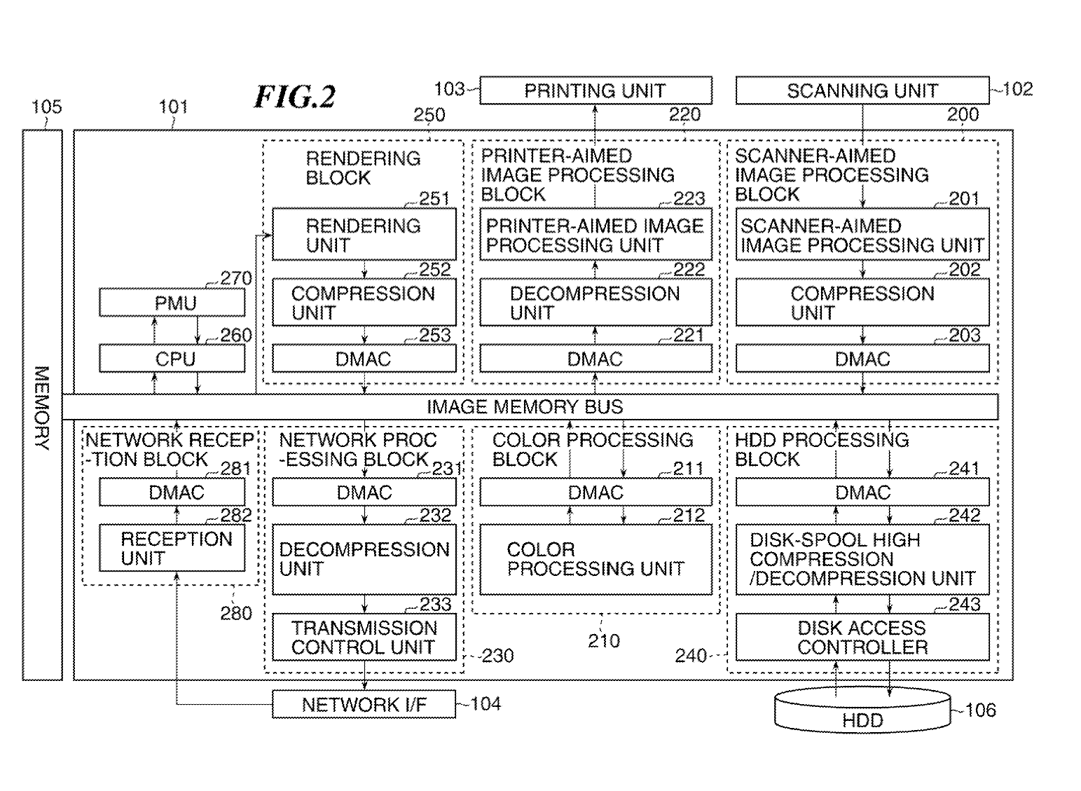

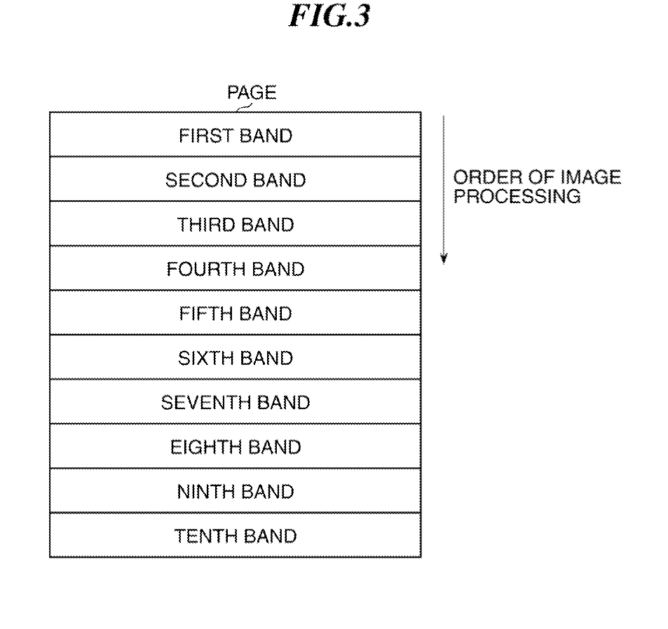

Next, an operation of the controller 101 in FIG. 1 will be described with reference to FIG. 2. It should be noted that a processing unit of the image data described below is a band that is one of a plurality of bands (ten bands, here) into which one page of image data is divided as shown in FIG. 3. In the controller 101, a predetermined operation process is executed in each of modules.

First, the case to read scan data will be described.

When receiving scan data (read image data) in three colors of RGB (Red, Green, and Blue) from the scanning unit 102, the controller 101 performs image processing (a shading process, a filtering process, etc.) by a scanner-aimed image processing unit 201. Then, an image compression process is applied to the scan data by a compression unit 202. The compressed data is stored into the memory 105 via a DMAC (Direct Memory Access Controller) 203. The functional block including the scanner-aimed image processing unit 201, the compression unit 202, and the DMAC 203 that perform the above-mentioned operations is a scanner-aimed image processing blocks 200.

When the scan data is printed, the compressed data stored in the memory 105 is inputted into a color processing unit 212 via a DMAC 211, and is converted into the CMYK (Cyan, Magenta, Yellow, Black) color space. Then, after applying color processing (a density control, a printer gamma correction, etc.) to the values of CMYK, the data is again stored into the memory 105 via the DMAC 211. The functional block including the DMAC 211 and the color processing unit 212 that performs the operation is a color processing blocks 210.

Then, the compressed data stored in the memory 105 is inputted into the decompression unit 222 via a DMAC 221, and is developed to raster image data in order to perform image processing for printing. The CMYK raster image data is inputted into a printer-aimed image processing unit 223, is subjected to area gradation processing by the dithering or the error diffusion method, and is outputted to the printing unit 103. The functional block including the DMAC 221, the decompression unit 222, and the printer-aimed image processing unit 223 that perform the operation is a printer-aimed image processing block 220.

When scan data is transmitted to a network, the compressed data stored in the memory 105 is inputted into the color processing unit 212 via the DMAC 211, and is subjected to color conversion. Specifically, after applying a display gamma adjustment, a sheet ground color adjustment, etc., the data is converted into the YCbCr (brightness, blue color difference, red color difference) color space. Then, the converted data is again stored into the memory 105 via the DMAC 211.

Then, the compressed data stored in the memory 105 is inputted into a decompression unit 232 via a DMAC 231, and is developed to raster image data in order to perform image processing for transmitting. The transmission processing unit 233 applies a JPEG compression process to the YCbCr raster image data in the case of color image transmission, or binarizes Y data and applies a JBIG compression process in the case of monochrome binary format image transmission, and outputs the processed data to the network I/F 104. The functional block including the DMAC 231, the decompression unit 232, and the transmission processing unit 233 that perform the operation is a network processing block 230.

When the scan data is saved, the compressed data stored in the memory 105 is inputted into a disk spool high compression/decompression unit 242 via a DMAC 241. Since the write speed of the HDD 106 is lower than that of the memory 105, the disk spool high compression/decompression unit 242 applies the JPEG compression process of higher compression to the compressed data. Then, the compressed data is saved into the HDD 106 via a disk access controller 243. A functional block including the DMAC 241, the disk spool high compression/decompression unit 242, and the disk access controller 243 that perform the operation is an HDD processing block 240. It should be noted that the opposite processing is required when the data stored in the HDD 106 will be developed onto the memory 105 again.

When PDL data is written into the memory 105, the PDL data is received by a reception unit 282 via the network, and is stored into the memory 105 via a DMAC 281. The functional block including the DMAC 281 and the reception unit 282 that perform the operation is a network reception block 280.

Next, the CPU 260 reads and interprets the PDL (Page Description Language) data stored in the memory 105, and outputs a display list to the memory 105. Then, a rendering unit 251 renders the display list stored in the memory 105 into RGB raster image data, and a compression unit 252 applies image compression processing to the RGB raster image data. Then, the compressed data is stored into the memory 105 via a DMAC 253. A functional block including the rendering unit 251, the compression unit 252, and the DMAC 253 that perform the operation is a rendering block 250.

When PDL image data is printed, is transmitted to the network, and is stored into the memory 105, the process similar to that for the scan data enables to achieve these functions.

A method of the power control performed in units of the blocks shown in FIG. 2 will be described.

A PMU (Power Management Unit) 270 outputs a power SW control signal and a reset control signal for each of the functional blocks mentioned above according to a command from the CPU 260. The power SW control signal is outputted for each functional block. The reset control signal is outputted to a reset control module (not shown) from the PMU 270. The reset control module controls reset release timing of each functional block.

Although this embodiment employs a mode power supply controlling method, there is another method that turns off all the functional blocks in the sleep mode, and turns on by outputting a signal to the PMU 270 from the CPU 260 when PDL data is received from the network.

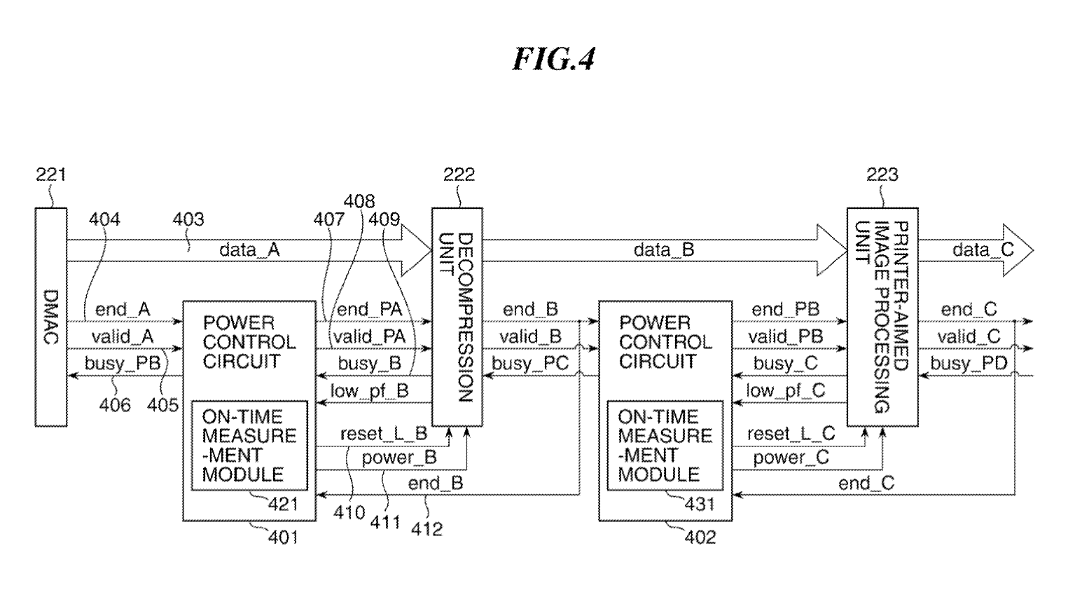

FIG. 4 is a block diagram schematically showing currents of signals between the printer-aimed image processing block 220 in FIG. 2 and power control circuits. FIG. 4 shows situation where the DMAC 221, the decompression unit 222, and the printer-aimed image processing unit 223 shown in FIG. 2 are connected by the bus as a pipeline. A power control circuit 401 controls ON/OFF of the power of the decompression unit 222, and controls a bus signal. A power control circuit 402 controls ON/OFF of the printer-aimed image processing unit 223, and controls a bus signal.

The bus signals (data effective signals) among the various modules (processing units) will be described while using the signals between the DMAC 221 and the decompression units 222 as an example.

The data A 403 is compressed data. The end A 404 is a signal showing that data of one band has been transferred from the DMAC 221. During the period when valid A405 is active, data A403 is effective. While the busy PB 406 is active, a reception side cannot receive data from the DMAC 221.

The end PA 407 and the valid PA 408 are signals that are outputted to indicate the states of the input signals end A 404 and valid A 405 to the power control circuit 401 as-is. The busy B 409 is a signal outputted to the power control circuit 401 from the decompression unit 222. When the decompression unit 222 is a power-OFF state, the busy PB 406 becomes active irrespective of the signal of the busy B 409. When the decompression unit 222 is a power-ON state, the state of busy B409 is outputted to busy PB406 as it is.

The reset L B 410 is a reset signal of the decompression unit 222. The power B 411 is a signal that controls power supplied to the decompression unit 222. The end B 412 is a signal showing that one band of data has been transferred from the decompression unit 222 to the printer-aimed image processing unit 223 that is the latter module.

Although FIG. 4 shows that the power control function is divided into the two circuits 401 and 402 for the respective power control targets, a single power control circuit may cover the power control targets.

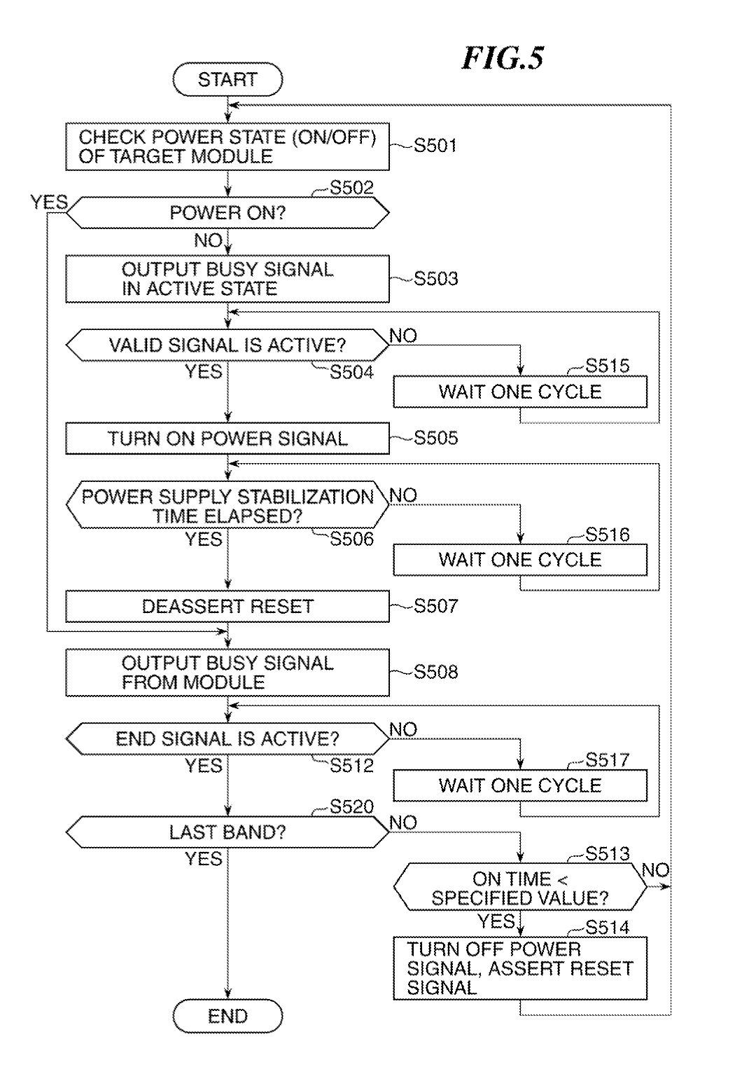

FIG. 5 is a flowchart showing a power control process by the power control circuits 401 and 402 in the first embodiment. This process corresponds to processing one page of image data, i.e., ten bands of image data.

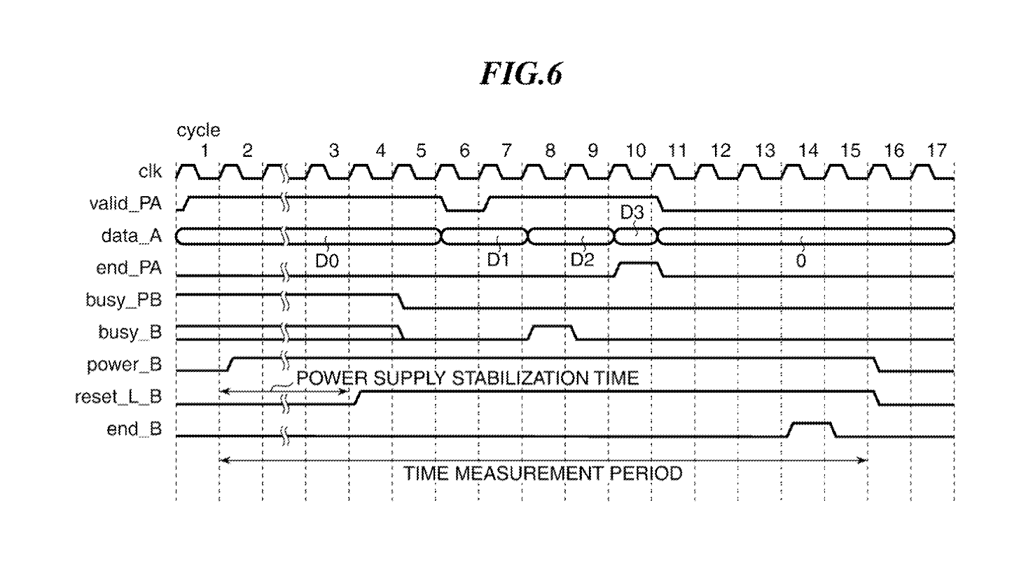

FIG. 6 is a view showing waveform examples of various bus signals shown in FIG. 4 during the power control process. In the illustrated example, data volume of one band is defined as four words in order to facilitate the description. The following description assumes that the process is executed by the power control circuit 401, unless otherwise specified. The process may be also executed by the power control circuit 402.

In step S501, the power control circuit 401 checks an ON/OFF state of a power control target module (the decompression unit 222, in this example). A power control target module may be one of the modules shown in FIG. 2, for example.

Next, in step S502, the power control circuit 401 determines whether the power control target module is in a power-ON state. When it is in the power-ON state, the process proceeds to step S508. On the other hand, when it is in a power-OFF state, the process proceeds to step S503.

In the step S503, the power control circuit 401 outputs the busy signal (busy_PB 406) of which the level is active state to the preceding module (the DMAC 221, in this example). That is, the power control circuit 401 makes the preceding module recognize that the target module is in a busy state. The preceding module is connected to the upstream side of the power control target module in the pipeline.

In step S504, the power control circuit 401 determines whether the valid signal outputted from the preceding module is active. When it is active, the power control circuits 401 proceeds with the process to step S505. On the other hand, when it is not active, the power control circuits 401 waits one cycle in step S515, and returns the process to the step S504 again. In the waveform shown in FIG. 6, it is equivalent to the cycle 1.

In step the 5505, the power control circuit 401 activates the power signal (power_B 411), and turns the power ON. In the waveform shown in FIG. 6, it is equivalent to the cycle 2. An ON time measurement unit 421 in the power control circuit 401 starts measurement from this time.

In step S506, the power control circuit 401 determines whether power supply stabilization time of the power control target module elapsed. The power supply stabilization time means time until a module becomes a stationary state after turning power ON. In the waveform shown in FIG. 6, it corresponds to a period from the cycle 2 to the cycle 3. Power supply stabilization time is decided by the amount of static current (circuit structure) consumed by a power control target module, and is beforehand set in the power control circuits 401 and 402. When the power supply stabilization time elapsed, the power control circuit 401 proceeds with the process to step S507.

In step the 5507, the power control circuit 401 deasserts the reset signal (reset_L_B 410), and releases a reset of the power control target module. In the waveform shown in FIG. 6, it is equivalent to the cycle 4.

In the step S508, the power control circuit 401 outputs the busy signal (busy_B 409) that the power control target module outputs as the busy signal (busy_PB 406) of the preceding module as-is. In the waveform shown in FIG. 6, it is equivalent to the cycle 5.

In step S512, the power control circuit 401 determines whether the end signal (end_B 412) outputted from the power control target module is active. When it is active, the power control circuit 401 recognizes the end of the belt, and proceeds with the process to step S520. On the other hand, when it is not active, the power control circuits 401 waits one cycle in step S517, and returns the process to the step S504 again.

In the step S520, the power control circuit 401 determines whether the processed band is the last band. If it is the last band, the power control circuit 401 finishes the process. If it is not the last band, the power control circuits 401 proceeds with the process to the step S513.

In the step S513, the power control circuit 401 acquires lapsed time (referred to as “ON time”) from the timing at which the ON-time measurement unit 421 started measurement in the step S505. If the power has been already ON in the step S502, the “ON time” is the lapsed time from the step S502. Then, the power control circuit 401 determines whether the acquired ON time (first lapsed time) is smaller than a specified value. When the ON time is smaller than the specified value, the power control circuit 401 proceeds with the process to step S514, inactivates the power signal (power_B 411), and turns the power OFF. Then, the power control circuit 401 asserts the reset signal (reset_L_B 410) to be the reset state. On the other hand, when it is determined that the ON time is larger than the specified value in the step S513, the power control circuit 401 returns the process to step S501 while keeping the power ON because the step S514 is skipped.

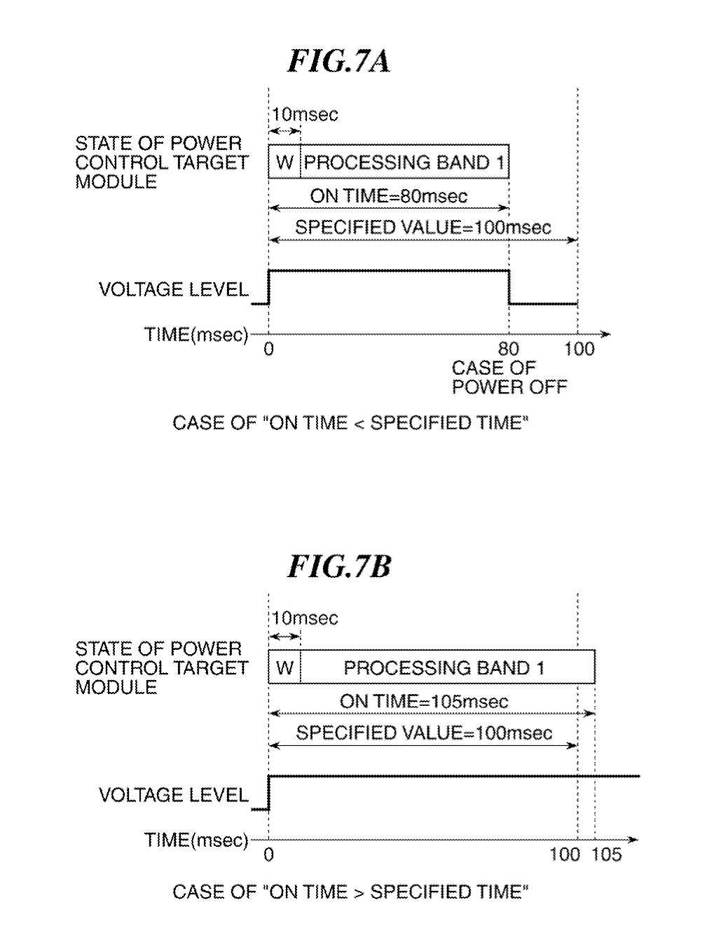

Here, a method for determining the specified value will be described with reference to FIG. 7A and FIG. 7B.

It is assumed that the printing unit 103 of the MFP takes one second to print one page. Since one page consists of ten bands, one band must be processed within 100 msec. When a series of bands each of which cannot be processed within 100 msec continue, the supply of image data is insufficient to the print operation. That is, a buffer underrun error occurs. Therefore, the specified value that is compared to the ON time acquired by the ON-time measurement unit is set to 100 msec. The power supply stabilization time of the decompression unit 222 as the power control target module is set to 10 msec.

FIG. 7A and FIG. 7B show examples where the decompression process starts after the power supply stabilization time (10 msec) lapses from the power turns ON at time 0.

In the example shown in FIG. 7 A, since the decompression process finishes within 80 msec, the condition of “ON time<specified value” is satisfied. Since there is a margin of 20 msec with respect to the time 100 msec that is required to process one band, the power control circuit 401 turns the power OFF for saving power.

On the other hand, in the example shown in FIG. 7B, since the decompression process takes 95 msec, the process finishes within 105 msec. That is, since the condition of “ON time >specified value” is satisfied, the power control circuit 401 does not turn the power OFF. Therefore, since it is unnecessary to set the power supply stabilization time before processing the next band, the occurrence of buffer underrun can be reduced.

In the examples in FIG. 7A and FIG. 7B, the specified value may be shorten from 100 msec to 95 msec in consideration of safety. Since delay of a local process is permitted when a buffer located between the decompression unit 222 and the printing unit 103 has sufficient capacity, a large specified value may be used. On the other hand, when the buffer capacity is insufficient, it is desirable to use a small specified value.

According to the first embodiment, the blocks of which the power supplies are isolated are connected by the bus as a pipeline, and the powers of the circuit modules can be turned ON without software control only when the operations are necessary. This is capable of reducing power consumption by controlling electric power without employing a complex control in a unit of a small-scale module.

Since the determination not to turn the power OFF can be performed without software control when the power OFF after finishing the data processing by the small-scale module loses necessary performance, the necessary performance can be maintained while saving power consumption.

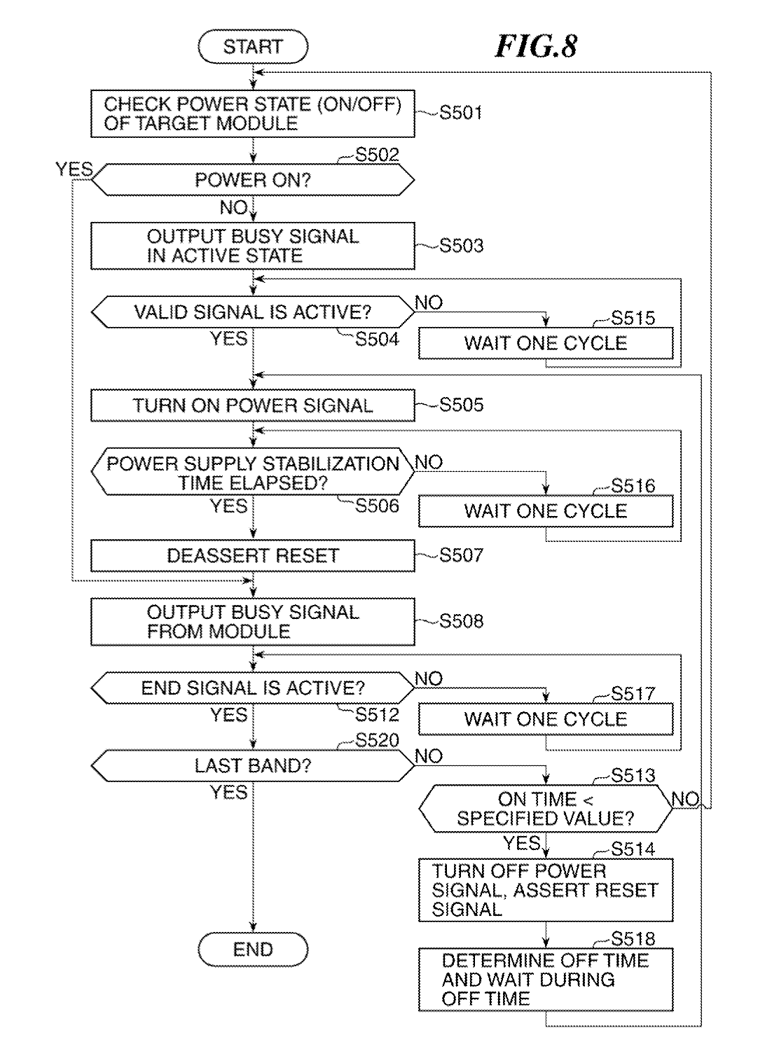

A configuration of an image forming apparatus according to the second embodiment is the same as that of the image forming apparatus according to the first embodiment (FIG. 1 through FIG. 4). Therefore, in the second embodiment, the same reference numbers are applied to elements corresponding to that in the first embodiment, and their descriptions are omitted. Hereafter, different points between the second embodiment and the first embodiment will be described with reference to FIG. 5 and FIG. 8.

In the first embodiment, the power control circuit 401 turns the power OFF in the step S514, proceeds with the process through the steps S501, S502, and S503, waits the valid signal in the step S504, and turns the power ON in the step S505 after receiving the Valid signal.

On the other hand, in the second embodiment, the power control circuit 401 decides OFF time (a second lapsed time) that is waiting time in step S518 after turning the power OFF in the step S514 in FIG. 8, and turns the power ON in the step S505 when the OFF time lapses.

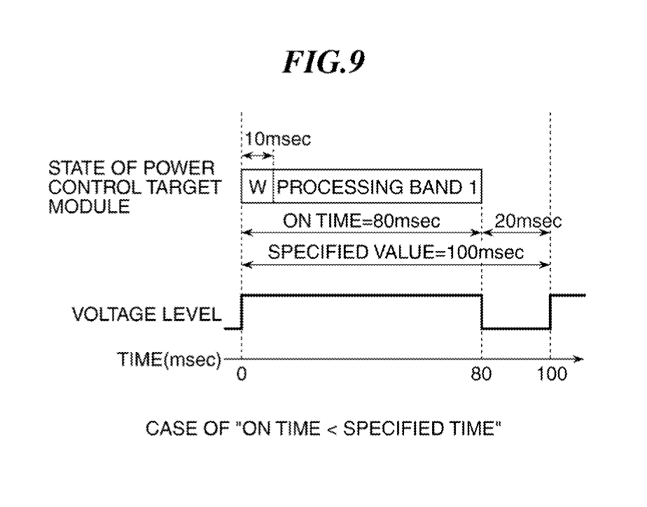

The way of thinking of the OFF time is described with reference to FIG. 9.

The only different point from the first embodiment is an operation when one band has been processed. The first embodiment turns the power ON when receiving the Valid signal as a trigger. On the other hand, in the second embodiment, since there is a margin of 20 msec if the process finishes within 80 msec as shown in FIG. 9, the OFF state is maintained without recourse to the Valid signal to give the power saving the priority. Since the power ON process immediately starts when 20 msec lapses, the occurrence of buffer underrun can be reduced.

In the second embodiment, although the OFF time is equal to (100 msec—ON time), the OFF time may be shortened in consideration of safety. For example, the OFF time may be equal to (95 msec—ON time). When the calculated difference becomes a negative value, the OFF time is set to “0”.

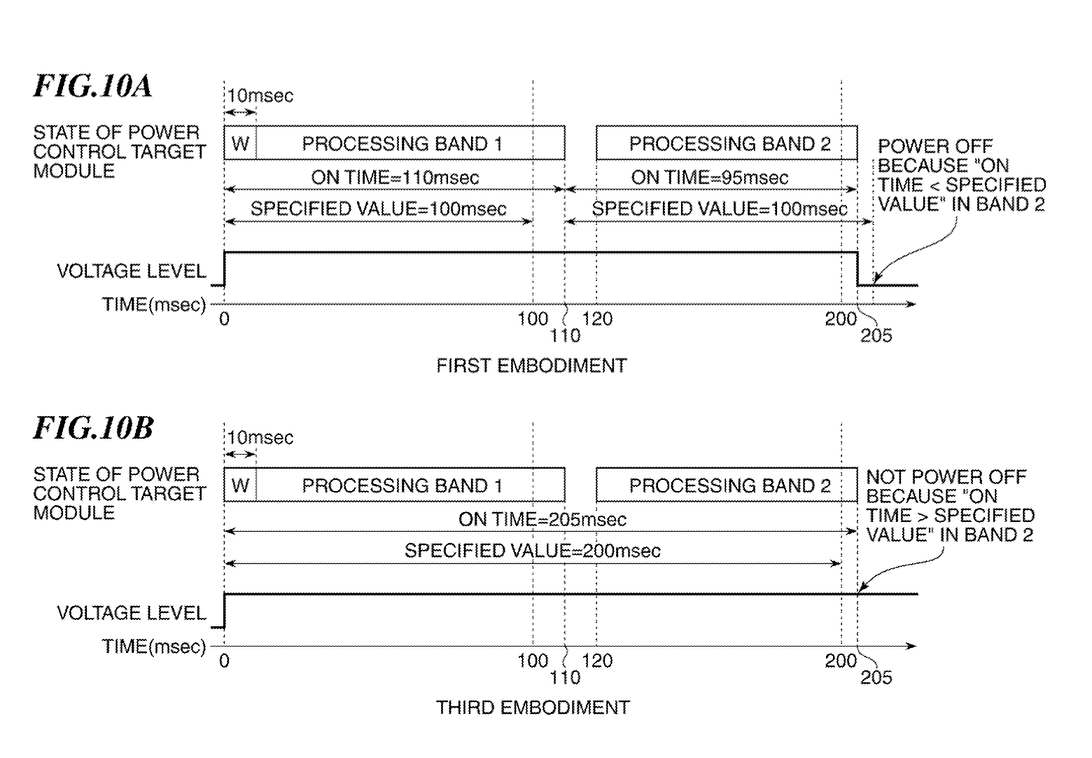

Next, a third embodiment of the present invention will be described. A configuration of an image forming apparatus according to the third embodiment is the same as that of the image forming apparatus according to the first embodiment (FIG. 1 through FIG. 4). Therefore, in the third embodiment, the same reference numbers are applied to elements corresponding to that in the first embodiment, and their descriptions are omitted. Hereafter, operations of the third embodiment will be described as compared to the operations of the first embodiment. FIG. 10A shows the operation of the first embodiment, and FIG. 10B shows the operations of the third embodiment.

Here, the case where the processing time for one band exceeds the time required to satisfy performance is focused.

Each of FIG. 10A and FIG. 10B show an example where the band 1 has been processed within 110 msec and the band 2 has been processed within 205 msec.

The first embodiment measures the ON time for every band. Therefore, the ON time becomes 95 msec at the time when the band 2 has been processed (205 msec lapses). Since the ON time is smaller than the specific value, the power is turned OFF. However, this is unsuitable in view of the entire process including the two bands. That's because it is necessary to process the two bands within 200 msec in order to satisfy the performance.

The third embodiment reduces the unsuitableness by measuring the processing time in unit of a plurality of bands. That is, as shown in FIG. 10B, the power control circuit 401 determined whether the power is turned OFF by comparing the ON time for two bands with the specified value for two bands (200 msec) in the step S513. Although the case using the ON time for two bands is described in the third embodiment, the number of bands is not limited to this. The circuit may determine whether the power is turned OFF based on the total ON time for a plurality of bands.

It should be noted that the value smaller than 200 msec may be selected as the specified value in consideration of safety to the buffer underrun.

Although the first through third embodiments describe the case where bands into which image data is divided are used in units for measuring the ON time of the power control target module, the image data may be divided in units of rectangles or may be divided in a unit of data quantity.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-123642, filed on Jun. 1, 2011, which is hereby incorporated by reference herein in its entirety.

What is claimed is:

1. An image forming apparatus that executes processes concerning image formation in units of modules, comprising:
a waiting unit configured to make a module wait an execution of a process until power supply stabilization time lapses after starting power supply to the module as a power control target;
a measurement unit configured to measure lapsed time until the power control target module has processed predetermined unit data after starting power supply; and
a determination unit configured to determine whether the power supply to the power control target module is turned OFF based on the lapsed time acquired by said measurement unit.

2. An image forming apparatus that executes processes concerning image formation in units of modules, comprising:
a waiting unit configured to make a module wait an execution of a process until power supply stabilization time lapses after starting power supply to the module as a power control target;
a measurement unit configured to measure first lapsed time until the power control target module has processed predetermined unit data after starting power supply;
a determination unit configured to determine whether the power supply to the power control target module is turned OFF based on the first lapsed time acquired by said measurement unit;
a decision unit configured to decide second lapsed time until the power supply is turned ON next after turning OFF; and
a power control unit configured to turn ON the power supply to the power control target module in response to a data effective signal inputted to the module concerned, to turn OFF the power supply to the power control target module when said determination unit determines to turn OFF, and to turn ON the power supply when the second lapsed time lapses after turning OFF the power supply concerned.

3. The image forming apparatus according to claim 2, wherein said decision unit decides the second lapsed time based on the sum total of the first lapsed times that are measured by said measurement unit at a plurality of measurements.

4. The image forming apparatus according to claim 1, wherein said determination unit determines whether the power supply is turned OFF based on the sum total of the lapsed times that are measured by said measurement unit at a plurality of measurements.

5. The image forming apparatus according to claim 2, wherein said determination unit determines whether the power supply is turned OFF based on the sum total of the first lapsed times that are measured by said measurement 10106180US01 unit at a plurality of measurements.

6. A power control method for an image forming apparatus that executes processes concerning image formation in units of modules, the power control method comprising:
a power-ON step of turning ON a power supply to a power control target module in response to a data effective signal inputted to the module concerned;
a waiting step of making the power control target module wait an execution of a process until power supply stabilization time lapses after starting power supply to the module in said power-ON step;
a measurement step of measuring lapsed time until the power control target module has processed predetermined unit data after starting power supply in said power-ON step;
a determination step of determining whether the power supply to the power control target module is turned OFF based on the lapsed time acquired in said measurement step; and
a power-OFF step of turning OFF the power supply to the power control target module when determining to be turned OFF in said determination step.

7. A power control method for an image forming apparatus that executes processes concerning image formation in units of modules, the power control method comprising:
a first power-ON step of turning ON a power supply to a power control target module in response to a data effective signal inputted to the module concerned;
a waiting step of making the power control target module wait an execution of a process until power supply stabilization time lapses after starting power supply to the module in said first power-ON step;
a measurement step of measuring first lapsed time until the power control target module has processed predetermined unit data after starting power supply in said power-ON step;
a determination step of determining whether the power supply to the power control target module is turned OFF based on the first lapsed time acquired in said measurement step;
a power-OFF step of turning OFF the power supply to the power control target module when determining to be turned OFF in said determination step;
a decision step of deciding second lapsed time until the power supply is turned ON next after turning OFF in said power-OFF step; and
a second power-ON step of turning ON the power supply when the second lapsed time lapses after turning OFF the power supply in said power-OFF step.

8. A non-transitory computer-readable storage medium storing a control program causing a computer to execute a power control method for an image forming apparatus that executes processes concerning image formation in units of modules, the power control method comprising:
a power-ON step of turning ON a power supply to a power control target module in response to a data effective signal inputted to the module concerned;
a waiting step of making the power control target module wait an execution of a process until power supply stabilization time lapses after starting power supply to the module in said power-ON step;
a measurement step of measuring lapsed time until the power control target module has processed predetermined unit data after starting power supply in said power-ON step;
a determination step of determining whether the power supply to the power control target module is turned OFF based on the lapsed time acquired in said measurement step; and
a power-OFF step of turning OFF the power supply to the power control target module when determining to be turned OFF in said determination step.

9. A non-transitory computer-readable storage medium storing a control program causing a computer to execute a power control method for an image forming apparatus that executes processes concerning image formation in units of modules, the power control method comprising:
a first power-ON step of turning ON a power supply to a power control target module in response to a data effective signal inputted to the module concerned;
a waiting step of making the power control target module wait an execution of a process until power supply stabilization time lapses after starting power supply to the module in said first power-ON step;
a measurement step of measuring first lapsed time until the power control target module has processed predetermined unit data after starting power supply in said power-ON step;
a determination step of determining whether the power supply to the power control target module is turned OFF based on the first lapsed time acquired in said measurement step;
a power-OFF step of turning OFF the power supply to the power control target module when determining to be turned OFF in said determination step;
a decision step of deciding second lapsed time until the power supply is turned ON next after turning OFF in said power-OFF step; and
a second power-ON step of turning ON the power supply when the second lapsed time lapses after turning OFF the power supply in said power-OFF step.
